(19) United States
(12) Patent Application Publication
(10) Pub. No.: US 2005/0253693 A1
(43) Pub. Date: Nov. 17, 2005

(54) Object detection system, apparatus, and method

(76) Inventors: Mark Rennick, Marietta, GA (US); Patricia Rennick, Marietta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/972,128

(22) Filed: Oct. 22, 2004

Related U.S. Application Data
(60) Provisional application No. 60/569,943, filed on May 11, 2004.

(51) Int. Cl. B60Q 1/00

(52) U.S. Cl. 340/435

(57) ABSTRACT

A system for detecting objects in the path of a vehicle includes a number of sensors, such as ultrasonic transducers, configured to emit and receive signals. The sensors are positioned in a bumper, a valance that couples to a bumper, or a similar device located near the rear of the vehicle so that the sensors emit signals in an area adjacent to the rear of the vehicle. A processing unit is positioned within a tray or similar device that mounts to the bumper, valance, etc. to create an essentially closed space to protect the processing unit from moisture and debris. The processing unit is electrically coupled to each sensor and is configured to output an alert signal to one or more alerting devices when an obstacle is detected by one or more of the sensors.

### CROSS-REFERENCE TO RELATED APPLICATION

This application claims priority to copending U.S. provisional application entitled, “Object Detection System, Apparatus, and Method,” filed May 11, 2004 and having Ser. No. 60/569,943, which is entirely incorporated herein by reference.

### TECHNICAL FIELD

The present disclosure generally relates to object detection systems and, more particularly, to a system, apparatus, and method for detecting objects and obstacles in the path of a vehicle.

### BACKGROUND OF THE INVENTION

Each year, many accidents occur when a driver of a vehicle attempts to move the vehicle in reverse, subsequently resulting in a collision with another object. A driver's view when driving in reverse is not as good as when a vehicle is moving forward, thereby causing most drivers to rely on rearview mirrors and/or to constantly turn and attempt to find obstacles. However, due to the relative position of the driver in the vehicle, the driver's vantage point oftentimes results in the failure to see and/or maneuver around various stationary or moving obstacles. Even worse, it is not uncommon for drivers of rear moving vehicles to strike other people who may walk or otherwise move into the path of the rear moving vehicle, unbeknownst to the driver. In these situations, when the obstacle is a person, such as a child who may dart into the path of the rear moving vehicle, the consequences can be catastrophic.

Even in relying on rearview mirrors when moving in reverse, a driver still may not be able to see a stationary or moving obstacle that may be in the driver's blind spot. Thus, it has become increasingly common for vehicles to be equipped with object detection systems to aid the driver in handling the vehicle so as to avoid obstacles in the path of the rear moving vehicle.

At least one solution includes placement of a camera in a rear portion of the vehicle so as to capture images of the area behind the vehicle, which is thereafter displayed on a screen viewable by the driver. In this way, a driver at least has a viewable image of the area behind the rear moving vehicle so as to see obstacles that may be in the path. However, even cameras are constrained by their respective fields of view, which means that a camera may also have a blind spot or experience poor resolution. Plus, weather conditions and other environmental conditions may result in a poor image quality viewed by the driver, thereby negating any beneficial effect that a camera system may provide.

Another solution includes equipping vehicles with automatic sensing systems to detect obstacles, which may include placement of one or more rear facing sensors that emit sonic waves from the rear of the vehicle. When an obstacle comes within the vehicle's path, the sonic waves may be disturbed and reflected back to the sensor, thereby indicating to the driver via processing electronics that an obstacle is in the path of the rear moving vehicle. Thus, it is possible according to this method to increase the awareness of the driver as to obstacles that may be in the rear path of the vehicle so as to prevent damage to the vehicle and/or injury to passengers in the vehicle or other persons that may be within the path as well.

Yet the solutions that have arisen incorporating ultrasonic and related technologies for obstacle detection systems have been plagued by many problems. In some applications, processing electronics associated with the ultrasonic sensors have been located at other points within the vehicle, thereby resulting in the inclusion of an additional preprocessor or signal amplifying unit located proximate to the sensors. The preprocessing unit may receive the signal from the various sensors and condition the signal for communication to the main processor that may actually be located near the front of the vehicle. However, this scheme results in a more expensive system due at least to the inclusion of both a main processing unit and a preprocessor or signal conditioner. Plus, the likelihood of failure of the entire system is therefore increased due to the additional components implemented in the system.

For existing vehicles without such systems installed during manufacture, replacing components, such as a bumper and other portions of the vehicle so as to equip such vehicles with object detection systems, is simply too expensive of an option both in parts and installation costs. As a nonlimiting example, if a latest model year Ford Explorer® is configured with an obstacle detection system in the bumper, equipping the previous model year with such a system would likely involve replacing the bumper assembly and other housings with components having an object detection system. Therefore, it quickly becomes economically unfeasible to equip existing vehicles with such systems irrespective of the safety benefits realized by such systems.

Thus, a heretofore unaddressed need exists to overcome the aforementioned deficiencies and shortcomings.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principals disclosed herein. Moreover, in the drawings, like reference numerals designate corresponding parts throughout the several views.

FIG. 1 is a diagram of the object detection system of the present disclosure.

FIG. 2 is a perspective view diagram of the master side portion and tray of the object detection system of FIG. 1.

FIG. 3 is a diagram of the tray with various electronics of the object detection system of FIG. 1.

FIG. 4 is a right side view diagram of the master side portion and tray of FIG. 2.

FIG. 5 is a left side view diagram of the slave side portion of FIG. 1.

FIG. 6 is a diagram of the master side portion and slave side portion of FIG. 1 with the processing unit electrically coupled to transducers.

FIG. 7 is a diagram of the wiring harness utilized in the slave side portion of FIG. 6 for coupling to the processor unit in the master side portion of FIG. 6.

FIG. 8 is a nonlimiting exemplary diagram of the master and slave side portions of FIG. 6 coupled to a vehicle.

FIG. 9 is a side view diagram of the bumper and master side portion of FIG. 8.

FIG. 10 is a diagram of the bumper and master side portion of FIG. 9 depicting ultrasonic energy being emitted by transducers in the master side portion of the object detection system.

FIG. 11 is a diagram of an alternate embodiment of the object detection system depicted in FIG. 8.

FIG. 12 is a nonlimiting exemplary diagram of the processing unit of FIG. 3

### DETAILED DESCRIPTION

In addition to the drawings discussed above, this description describes one or more embodiments as illustrated in the above-referenced drawings. However, there is no intent to limit this disclosure to a single embodiment or embodiments that are disclosed herein. On the contrary, the intent is to cover all alternatives, modifications, and equivalents included within the spirit and scope of this disclosure and as defined by the appended claims.

This disclosure describes the integration of one or more object detection sensors and control circuitry in a housing for use within a vehicle to detect objects and other hazards to the vehicle. The integrated unit, when used on a vehicle, can provide data to a driver maneuvering the vehicle so as to prevent collisions with moving and stationary objects.

More specifically, this disclosure relates to a system, method, and apparatus for detecting objects in the path of a vehicle by implementing a number of sensors, such as ultrasonic transducers, to emit and receive signals. The sensors are positioned in a bumper, a valance coupled under a bumper, or a similar device located near the rear of the vehicle so that the sensors emit signals in an area adjacent to the rear of the vehicle. A processing unit is positioned within a tray or similar device that mounts to the bumper, valance, etc. to create an essentially closed space. The tray protects the processing unit from moisture and debris. The processing unit is electrically coupled to each sensor and is configured to output an alert signal to one or more alerting devices when an obstacle is detected by one or more of the sensors.

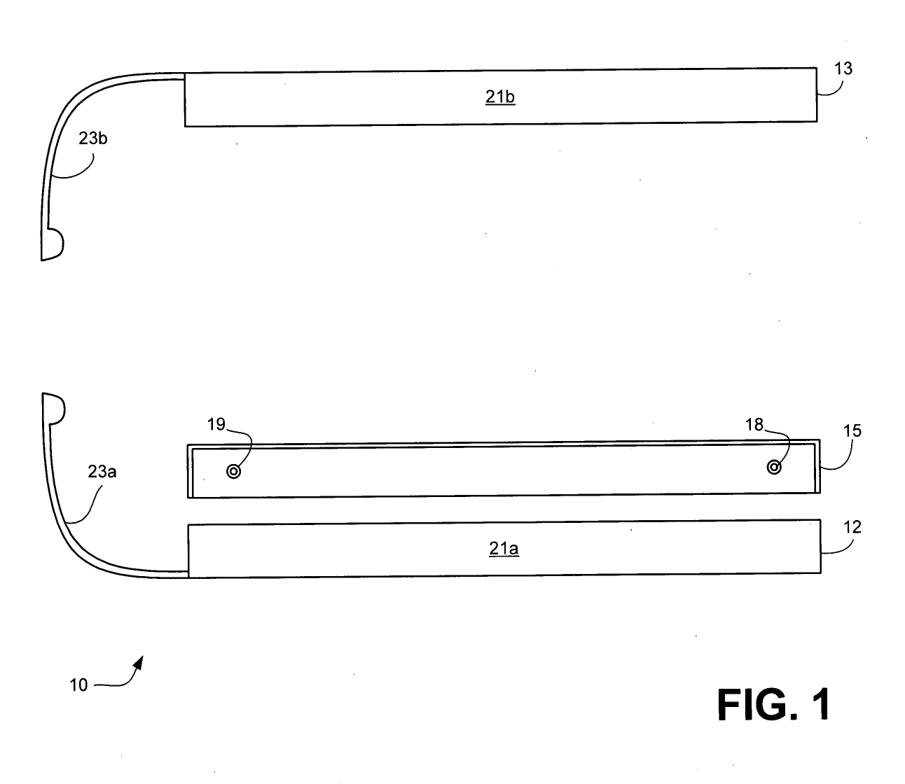

FIG. 1 is a diagram of the object detection system 10 of the present disclosure. Object detection system 10 includes a first portion 12 and second portion 13, which for purposes of this disclosure will be referred to as master side 12 and slave side 13. However, one of ordinary skill in the art would know that designation of each side as master and slave is for descriptive purposes only and is not intended to be limiting upon the scope of this disclosure in any way.

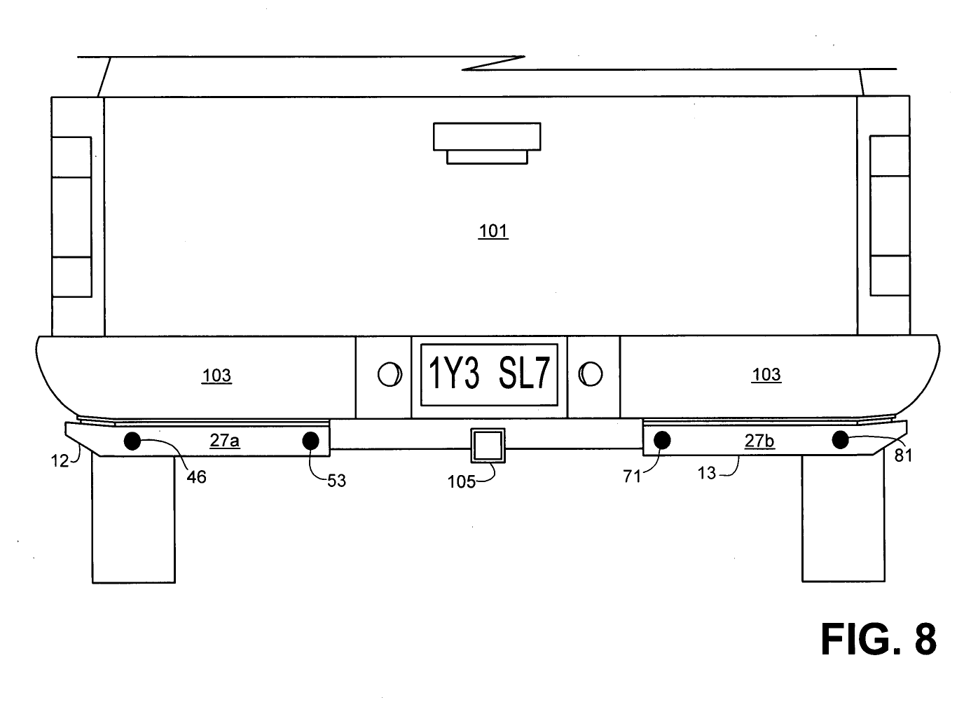

In one nonlimiting example, the object detection system 10 is configured to attach to a vehicle at or near a bumper assembly such that ultrasonic sensors (or other object detection devices) positioned in master and slave sides 12 and 13 may direct ultrasonic energy (or by other means) to a rear area of the vehicle. Thus, in one nonlimiting example, the object detection system 10 is configured to mount on its top side 21a and 21b to a bottom portion of a bumper of a vehicle, as shown in FIGS. 8-10.

Therefore, the master side portion 12 is comprised of top portion 21a which may be configured for mounting to an underside of a vehicle bumper. Master side portion 12 also includes rounded portion 23a that may be fashioned to curve around a back left corner of the vehicle for which the object detection system 10 is mounted.

In similar fashion, slave side portion 13 includes a top portion 21b that may mount to the underside of a vehicle bumper and a curved portion 23b to curve around the back right corner of the vehicle's bumper. Thus, in this way, the curved portions 23a and 23b are configured so that the master side portion 12 and slave side portion 13 contour to the vehicle in an aesthetically pleasing fashion.

Also, tray 15 is included in object detection system 10, as shown in FIG. 1. As discussed in more detail below, tray 15 couples to master side portion 12 to create a sealed housing for processing circuitry. Tray 15 may include slots 18 and 19 for receipt of screws or other fastening means for attaching tray 15 to master side portion 12.

One of ordinary skill in the art would know that the object detection system 10, as shown in master side portions 12 and 13, may be contoured for a variety of vehicle makes and models. Stated another way, master side portion 12 and slave side portion 13 are merely nonlimiting examples and not intended to be limited to any single shape or configuration.

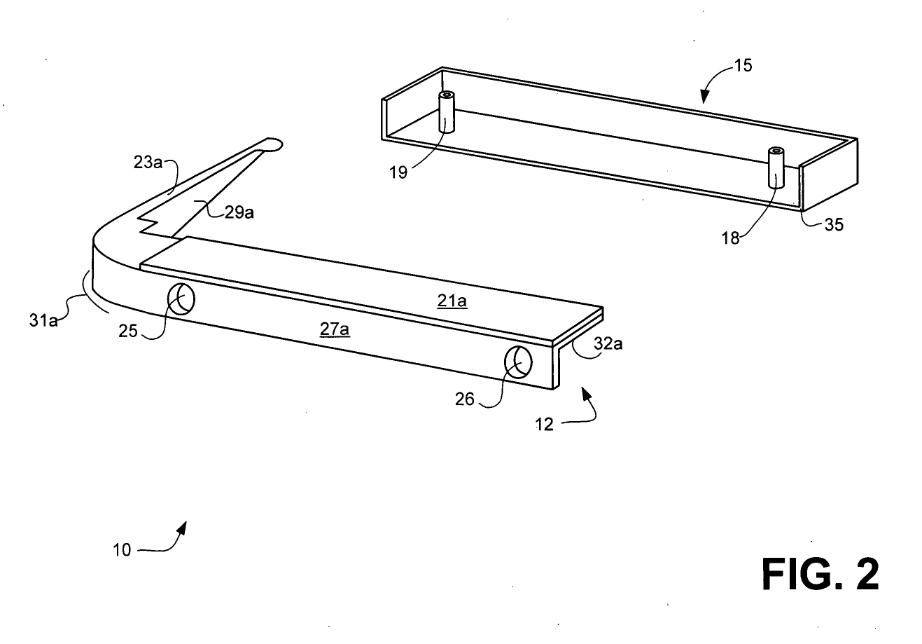

FIG. 2 is a perspective view diagram of master side portion 12 and tray 15 of the object detection system 10 of FIG. 1. In this view, top portion 21a may be coupled to and valance 27a that is configured to receive tray 15. Valance 27a may include one or more receptacle locations 25 and 26 for receipt of object detection sensors, such as ultrasonic transducers. One of ordinary skill in the art would know, however, that a greater or lesser number of receptacle locations 25, 26 may be positioned in valance 27a.

Valance 27a includes rounded portion 31a that is configured to mount below the left rear corner of the vehicle to which the object detection system 10 is installed. Thus, surface 23a extends under the bumper at the left rear side of the vehicle to which the system 10 is installed. Side portion 29a may be included so as to improve the contouring and structural integrity of the master side portion 12 (and likewise on slave side portion 13) as it curves around the left rear corner of the vehicle.

Turning to tray 15 in FIG. 2, surface edge 35 is configured to couple with the interior surface 32a of valance 27a. In this way, tray 15 serves to create a sealed molded case wherein when coupled to the master side portion 12 so that processing electronics may be positioned within the space created by the mating of tray 15 and master side portion 12.

In this way, electronics positioned within tray 15 are protected from environmental conditions that may typically exist at the underside of a vehicle bumper. More specifically, the processing electronics would be protected from water, dirt, road debris, etc. As stated above, slots 18 and 19 are configured for receipt of fastening mechanisms such as screws, bolts, etc. such that tray 15 may be secured to master side portion 12. One of ordinary skill in the art would know that a greater or lesser number of slots 18 and 19 may be included on tray 15 (with associated holes in the surface 32a of valance 27a) so as to create a uniform seal between surface 35 and the under surface 32a of valance 27a. One of ordinary skill would also know that various sealing devices, such as a rubber strip, could also be used to create a tighter seal.

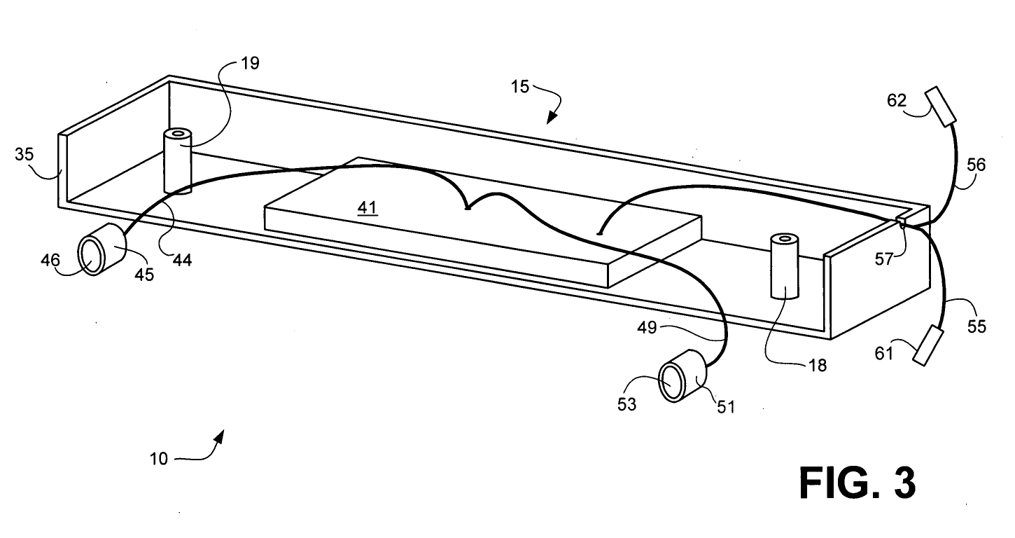

FIG. 3 is a diagram of tray 15 depicting processing electronics of the object detection system 10 of FIG. 1. As indicated above, the object detection system 10 may be equipped with one or more optical sensors to detect moving and stationary objects within the rear driving path of the vehicle.

The object detection system 10 may be equipped with an ultrasonic transducer or microwave emitter or other type of optical sensor, such as a camera or other detection device. One of ordinary skill in the art would know of one or more various types of detection devices that may be used as the sensing mechanism in the object detection system 10. Moreover, this disclosure is not intended to be limited to any one type of sensor or sensing technology.

As one nonlimiting example among others, the sensors implemented in the object detection system 10 may comprise ultrasonic transducers 46 and 53. Transducers 46 and 53 may be positioned within isolators 45 and 51, respectively, and coupled to a processing unit 41 via connectors 44 and 49.

Processing unit 41 is shown positioned within tray 15 so that when coupled to master side portion 12, processing unit 41 is proximately nearby transducers 46 and 53. In this way, the location of processing unit 41 within tray 15 eliminates inclusion of preprocessing circuitry and/or signal conditioning circuits for communicating the signal from transducers 46 and 53 to distal locations within the vehicle wherein the processor may otherwise be installed.

One of ordinary skill in the art would know of various processing circuits that may be implemented as the processing unit 41 for communication with ultrasonic transducers 46 and 53 of the object detection system 10. Thus, processing unit 41 is not limited to a particular processor or computing system, but is instead intended to represent any type of processing unit capable of receiving input from one or more optical detectors and for communicating an obstacle detection signal to one or more alerting means or devices.

Processing unit 41 may also include connectors 55 and 56, which have couplers 61 and 62, respectively. Coupler 61 may be coupled to transducers in slave side portion 13. Likewise, connector 56 and coupler 62 may be coupled to a power source and/or alerting devices, etc.

As described above, surface edge 35 is configured to mate with the interior surface 32a of valance 27a so as to create a uniform seal to protect processing unit 41. Tray 15 may include, however, one or more wiring bypasses 57 to allow for various connectors to be coupled to the processing unit 41 within tray 15 and one or more electrical devices outside of tray 15.

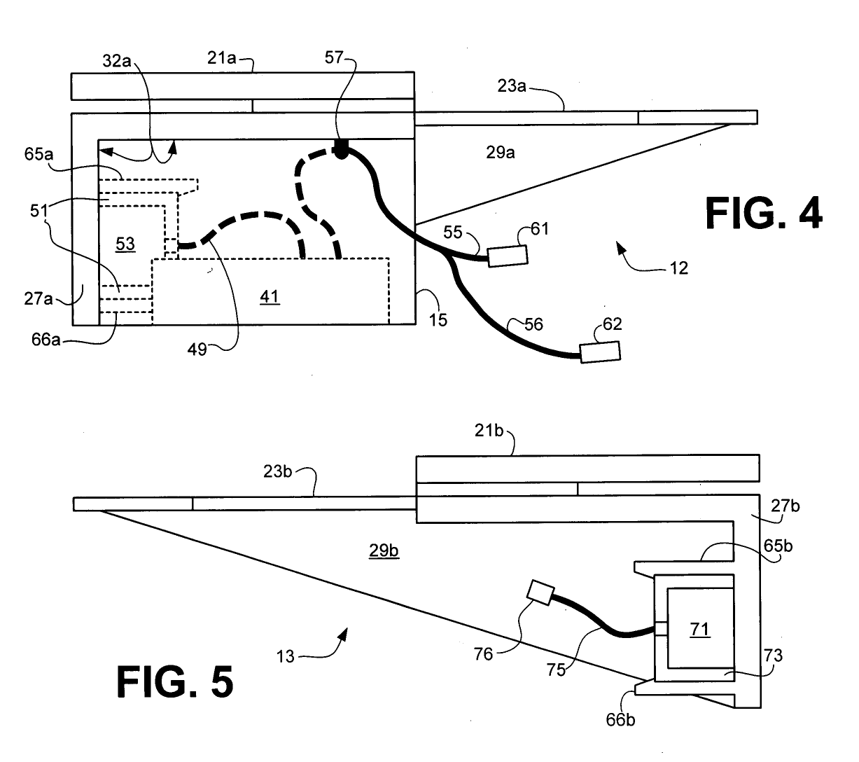

FIG. 4 is a right side view diagram of the master side portion 12 and tray 15 with interior components within tray 15 shown as dashed lines to assist in understanding of this disclosure. As stated above, top portion 21a is coupled to the bottom side of a bumper of the vehicle. Likewise, surface 23a is coupled to an underside of the bumper around the left rear side of the vehicle such that slanted portion 29a extends downward under the left rear corner of the bumper of the vehicle, as described above.

As shown in FIG. 4 and as also stated above, tray 15 is coupled to the interior surface 32a of valance 27a. Thus, as described above, a sealed space is created so as to house processing unit 41 that is electrically coupled via connector 49 to transducer 53. Transducer 53 includes isolator 51 which is coupled to valance 27a via snap-in connectors 65a and 66a, which may be an integral portion to the valance 27a.

As also described above, one or more wiring bypasses 57 may be configured to allow connectors 55 and 56 to route from processing unit 41 to one or more other transducers, such as in slave portion 13 and a power source and/or one or more alerting devices. More specifically, processing unit 41 may be powered by a power source coupled via a coupler 62 and connector 56 such that processing unit 41 may cause transducers, such as transducer 53, to emit ultrasonic energy for object detection operations. In this way, processing unit 41 may be positioned under the rear bumper of a vehicle in a location that may otherwise be inhospitable to electrical circuitry. Moreover, by positioning processing unit 41 near transducer 53 and the other transducers of the object detection system 10, the object detection system 10 does not utilize an amplifier or other signal conditioning circuitry for communicating output from the transducers to the processing unit, which may otherwise be distally located from the assembly. This configuration eliminates the need for a preprocessor at the sensor because of the inclusion of the processing unit within the object detection system 10.

FIG. 5 is a left side view diagram of slave side portion 13. In this figure, portion 21b couples to the underside of the vehicle bumper, in similar fashion as piece 21a. Likewise, portion 23a is configured to curve around the right rear corner of the vehicle and extend up a predetermined length of the right rear side of the vehicle for which the object detection system 10 is installed. As similar to master side portion 12, slanted side piece 29b slants downwardly and curves around the right rear corner of the vehicle creating an aesthetically pleasing appearance.

As indicated above, the valance 27b may be configured with snap-in portions 65b and 66b such that the isolator 73 of transducer 71 may attach to valance 27b. This configuration allows for the easy replacement of malfunctioning transducers (or initial installation of transducers), as well as simplified manufacturing techniques, as one of ordinary skill in the art would know. However, one of ordinary skill would know that other installation methods may be implemented as well.

In this nonlimiting example shown in FIG. 5, transducer 71, being fastened to valance 27b via isolator 73 that snaps into fasteners 65b and 66b, includes electrical connector 75 and coupler 76 for mating to coupler 61 and connector 55 of FIG. 4. As shown in more detail below, when master side and slave side portions 12 and 13 are coupled to the underside of a bumper of a vehicle, connectors 75 and 55, via couplers 61 and 56, allow for transducer 71 to be electrically coupled to processing unit 41 of FIG. 4.

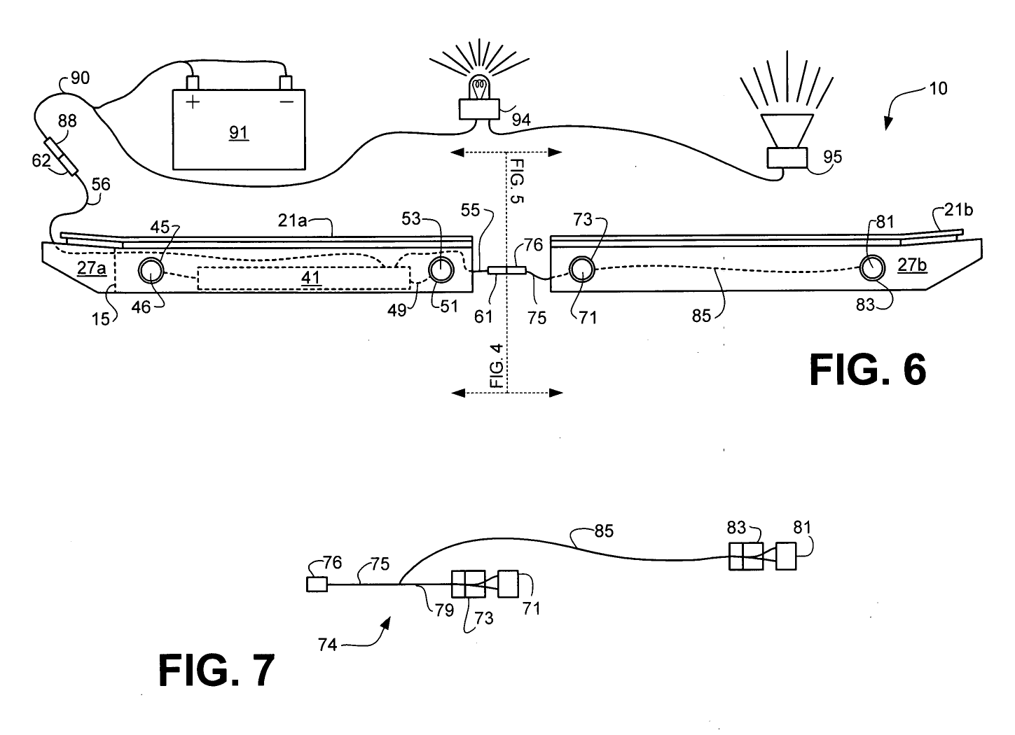

FIG. 6 is a diagram of the master side portion 12 and slave side portion 13 of FIG. 1 with the processing unit 41 electrically coupled to transducers in each portion 12 and 13. In this nonlimiting example, processing unit 41 is shown in dashed lines, as one of ordinary skill in the art would know that processing unit 41 would otherwise be positioned within the space created by tray 15 coupled to valance 27a. In this nonlimiting example, tray 15 is represented in FIG. 6 as a dashed line to show its coupling to the valance 27a.

In FIG. 6, processor 41 is electrically coupled to transducer 46 that is mounted within isolator 45 as well as transducer 53 that is mounted within isolator 51. Each of transducers 46 and 53 are snapped into mountings, as described in FIGS. 4 and 5, in master side portion 12.

Processing unit 41 is also electrically coupled to transducers 71 and 81 in slave side portion 13 via connectors 55 and 75 that are joined by couplers 61 and 76. Thus, transducer 71, that is positioned within isolator 73, and transducer 81, that is positioned within isolator 83, may be electrically coupled via connectors 75 and 85 to the processing unit 41. One of ordinary skill in the art would know that the length of the connectors described above may vary and be configured according to the dimensions of the actual vehicle for which the object detection system 10 of FIG. 6 is installed. Plus, as described above, one or more additional transducers in addition to the four shown in FIG. 6 may be positioned within master and slave side portions 12 and 13 as one of ordinary skill in the art would know.

Processing unit 41 may also be coupled to power source 91 and one or more alerting devices 94, 95 via connector 90 shown in FIG. 6. More specifically, connector 56, which is coupled to processing unit 41, may be coupled to connector 90 via couplers 62 and 88. Thus, the vehicle's battery 91 may be electrically coupled to the processing unit 41 for powering the transducers 46, 53, 71, and 81, as one of ordinary skill in the art would know.

Likewise, processing unit 41 may be electrically coupled via connectors 56 and 90 to visual alerting device 94 and audible alerting device 95. In this nonlimiting example, visual alerting device 94 may be any visual alerting means for communicating to the driver of the vehicle for which the object detection system 10 is installed, as one of ordinary skill in the art would know. As nonlimiting examples, various lights and other visual indicators that may be controlled by processing unit 41 may serve as visual alerting device 94. As an additional nonlimiting example, visual alerting device 94 may be built into the dashboard display of the vehicle.

Likewise, processing unit 41 may be configured to activate audible alerting device 95 so as to create an audible tone, indicating to the driver the presence of a detected obstacle in the rear path of the vehicle. Audible alerting device 95, as a nonlimiting example, may be the vehicle's horn or other preexisting buzzer (or similar device), as one of ordinary skill in the art would know.

As additional nonlimiting examples, connector 56 may also be electrically coupled to one or more additional processing circuits such as a circuit that indicates that the vehicle is shifted into reverse gear. More specifically, when the driver of a vehicle for which the object detection system 10 is installed shifts the vehicle into reverse gear, an additional processing circuit (not shown) may communicate a signal to processing unit 41 via connector 56, thereby activating processing unit 41 and the transducers 46, 53, 71, and 83. Otherwise, processing unit 41 may be in a standby mode or sleep state so as to not generate false object detection signals.

Returning to the visual and audible alerting devices 94 and 95, processing unit 41 may be configured to vary the visible and audible alerting indications in correspondence to the distance of the detected object relative to the vehicle. One of ordinary skill in the art would know that transducers 46, 53, 71, and 81 may generate varied signals depending upon the distance of detected objects from the detecting transducer(s). Thus, processor 41 may calculate the distance from the transducer to the detected object and vary the output signal to each of the alerting devices 94 and 95 accordingly. Thus, as a nonlimiting example, visual alerting device 94 may be configured to flash slowly when an object is detected at a greater distance and flash more frequently or brighter when an object is in a closer or even critical position respective to the vehicle. Similarly, audible alerting device 95 may be configured to emit a tone of a certain predetermined volume for objects detected at further distances, and tones of greater volume and intensity as the vehicle approaches objects within the rear path of the vehicle.

FIG. 7 is a diagram of the wiring harness 74 utilized in slave side portion 13 for coupling to the coupler 61 and connector 55 that is coupled to processor unit 41 in master side portion 12 of FIG. 6. Harness 74 includes coupler 76 for joining with coupler 61 of FIG. 6 and is configured to branch into connectors 79 and 85, which may be furthermore coupled to transducers 71 and 81, respectively. In this nonlimiting example, transducer 71 is shown separated from isolator 73, and transducer 81 is shown separated from isolator 83 to clarify the relationship between these components. One of ordinary skill in the art would know, however, that the connectors 75, 79, and 85 may be various lengths according to the positioning of transducers 71 and 81 in the slave side portion 13. Also, the wiring harness 74 may be also configured with additional connectors for one or more additional transducers.

FIG. 8 is a diagram of the master and slave side portions 12 and 13 coupled to vehicle 101. More specifically, master side portion 12 and slave side portion 13 are coupled to the underside of bumper 103 of vehicle 101. In this way, valances 27a and 27b are essentially perpendicular to the ground such that transducers 46, 53, 71, and 81 may direct ultrasonic energy into the rear path of the vehicle when activated.

Although not visible in this figure, the wiring harness 74 of FIG. 7 may be extended to electrically couple slave side portion 13 to the processor 41 within master side portion 12 and tray 15. The wiring harness 74 may be routed around trailer hitch receptacle 105 and any additional components that may be located in this area of vehicle 101. Nevertheless, transducers 71 and 81 may be electrically coupled by the wiring harness 74 of FIG. 7 to the processing unit 41 so as to detect obstacles on a right rear portion of vehicle 101. One of ordinary skill in the art would know, however, that valances 27a and 27b may be configured differently from as shown in FIG. 8 according to the various vehicle types for which the object detection system 10 is installed.

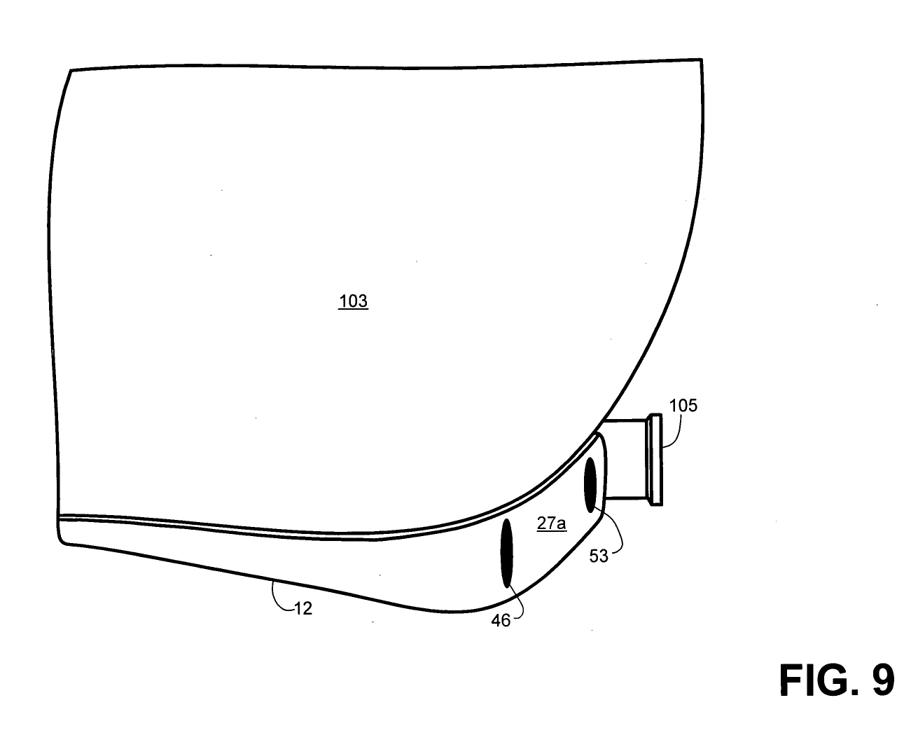

FIG. 9 is a close-up side diagram of bumper 103 and master side portion 12 of FIG. 8. As described above, valance 27a extends essentially perpendicular to the ground and extending beneath bumper 103 so that transducers 46 and 53 may direct ultrasonic energy into an area behind the vehicle and bumper 103. One of ordinary skill in the art would know that valance 27a could be configured at angles respective to the ground that are not perpendicular, depending on the type of vehicle and sensors used. One of ordinary skill in the art would also understand that slave side portion 13 may be positioned under bumper 103 on the opposite side of trailer hitch insert 105, which otherwise obstructs master side portion 13 from FIG. 9.

In this way, master side portion 12 and slave side portion 13 extend beneath bumper 103 in a manner that does not interrupt the aesthetic appearance of the vehicle 101 but instead looks to be an integral part of the vehicle. At the same time, location of processing unit 41 within tray 15, which is obscured in FIG. 9 by valance 27a, eliminates the need for the preprocessing circuitry described above and enables a driver to be alerted to objects that may be in the rear driving path of the vehicle.

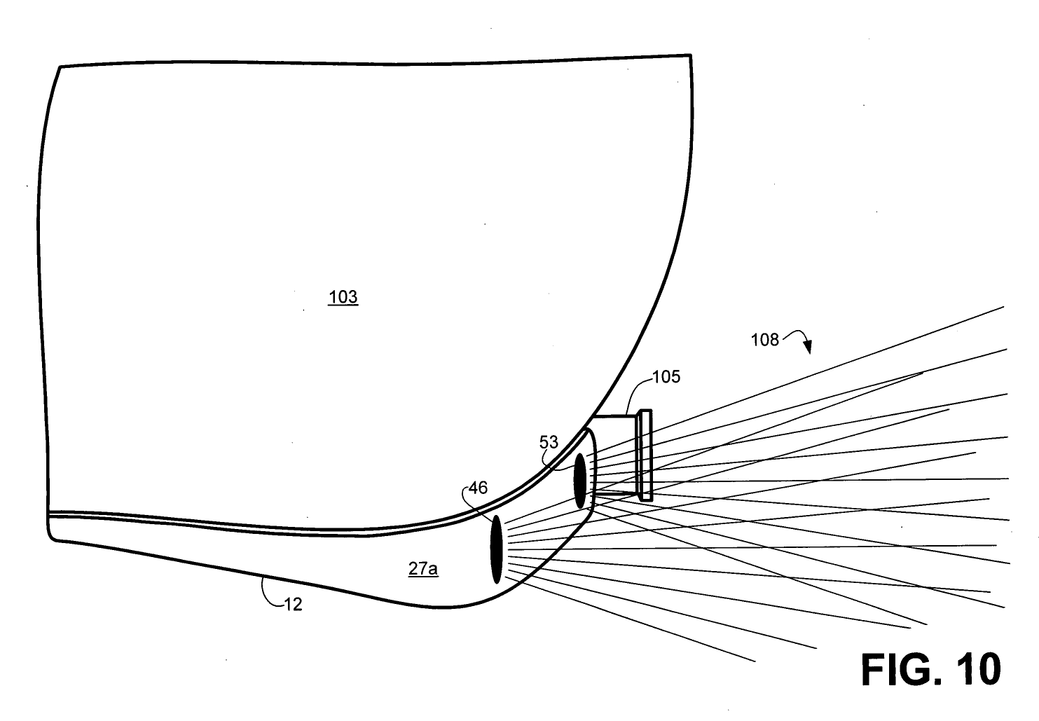

FIG. 10 is a diagram of the bumper and valance assembly 27a of FIG. 9. However, in this figure, ultrasonic energy 108 is shown as being emitted into the rear path of vehicle 101 (attached to bumper 103—in FIG. 8).

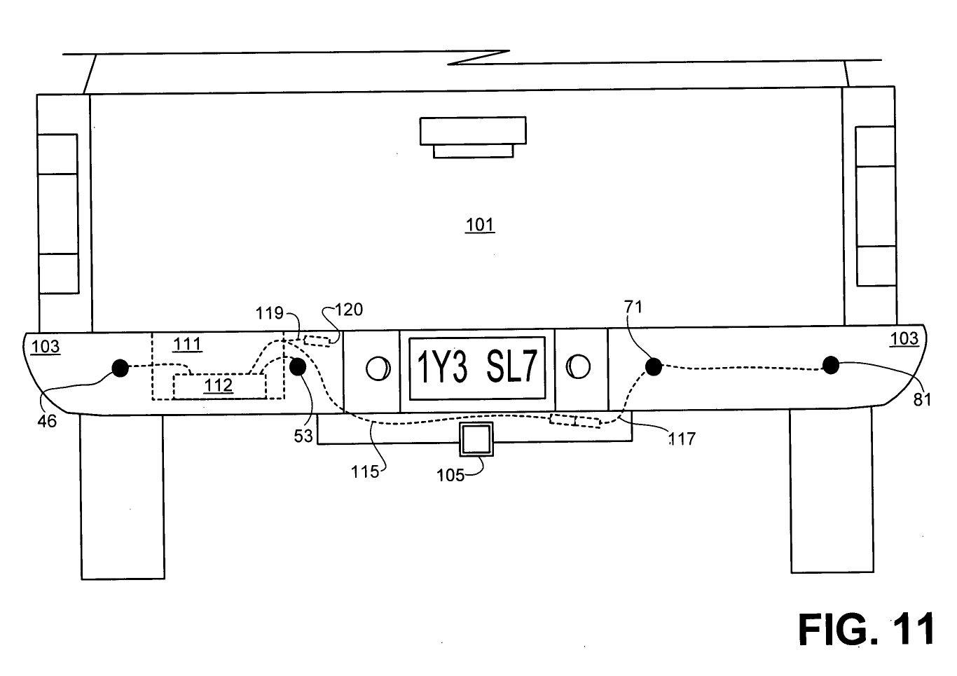

FIG. 11 is a diagram of an alternate embodiment of the object detection system depicted in FIG. 8. Specifically, the transducers 46, 53, 71, and 81 in this nonlimiting example are positioned in the bumper 103 itself. Likewise, tray 111 is seal to an interior surface of bumper 103 in similar fashion as tray 15 is described above in regard to valance 27a.

Processing unit 112 is electrically coupled to the transducers 46 and 53, as shown in FIG. 11. Likewise, processing unit 112, which is in the closed space created by tray 111, is coupled to sensors 71 and 81 via wiring harnesses 115 and 117. Power is supplied to processing unit 112 via coupler 120 and connector 119 (not actually shown in this figure, but see FIG. 6). Thus, this nonlimiting example in FIG. 11 depicts that he object detection system of this disclosure may be configured in the bumper itself or in other components attachable to the bumper or other similar area.

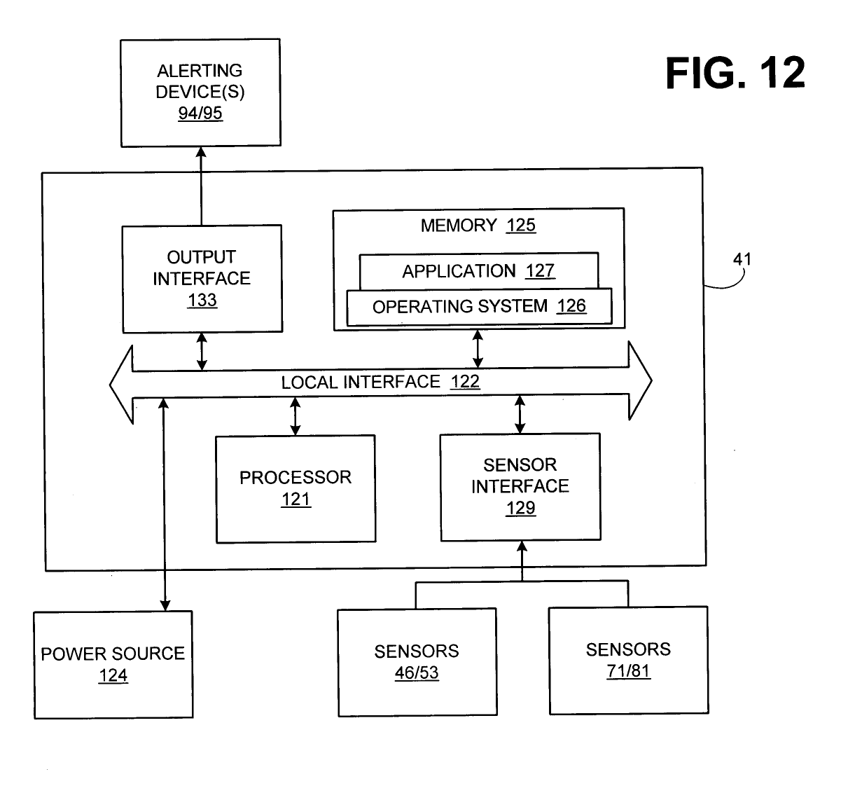

FIG. 12 is a nonlimiting exemplary diagram of a processing unit, as shown in FIG. 3 (and elsewhere in this disclosure). One of ordinary skill in the art would know that multiple configurations and implementations of such processing units could suffice, and that this illustration is merely a nonlimiting example of one such implementation. Thus, as a nonlimiting example, processing unit 41 may be comprised of the processor 121 that communicates by a local interface 122 with memory 125, all of which that is powered by power source 124. An operating system 126 and application specific software 127 may be contained in memory 125. The application specific software 127 may include one or more of the processes related to controlling the transducers and reporting detected objects.

Accordingly, a signal is communicated from sensors 46, 53, 71, and 81 to the sensor interface 129 for processing by processor 121. When the sensors report detection of an object, processor 121 communicates an output signal via output interface 133 to alerting devices 94, 95.

It should be emphasized that the above-described embodiments and nonlimiting examples are merely possible examples of implementations, merely set forth for a clear understanding of the principles disclosed herein. Many variations and modifications may be made to the above-described embodiment(s) and nonlimiting examples without departing substantially from the spirit and principles disclosed herein. All such modifications and variations are intended to be included herein within the scope of this disclosure and protected by the following claims.

1. A system for detecting objects in the path of a vehicle, comprising:
one or more sensors configured to emit a signal and to receive a reflected signal;
one or more receivers configured to position the one or more sensors in an orientation so that the sensors emit the signals into a desired area adjacent to the vehicle;
at least one tray configured to couple to at least one receiver to created an essentially closed space between the receiver and the tray; and
a processing unit coupled to each of the one or more sensors and positioned in the essentially closed space and configured to receive signals from the one or more sensors and further configured to output an alert signal when an object is detected by one or more of the sensors.

2. The system of claim 1, further comprising:
one or more sealed entryways in the tray configured for one or more connectors to be routed from the processing unit to a location outside of the closed space.

3. The system of claim 1, wherein the tray is configured as a portion of the receiver.

4. The system of claim 1, a first receiver is coupled to a vehicle bumper on a first side of the vehicle, and wherein a second receiver is coupled to the vehicle bumper on a second side of the vehicle, and further wherein the tray is coupled to the first receiver and the processing unit is coupled to the one or more sensors in the second receiver by a wiring harness that extends from the second receiver to the first receiver so that sensors in the first and second receiver are electrically coupled to the processing unit that is also electrically coupled to a power source and one or more alerting devices.

5. The system of claim 4, wherein at least one alerting device is an audible alerting device.

6. The system of claim 5, wherein the processing unit is configurable to vary the audible alert produced by the audible alerting device in association with the distance of a detected object from the vehicle.

7. The system of claim 4, wherein at least one alerting device is a visual alerting device.

8. The system of claim 7, wherein the processing unit is configurable to vary the visual alert produced by the visual alerting device in association with the distance of a detected object from the vehicle so as to communicate increasing or decreasing proximity.

9. The system of claim 1, further comprising:
sensor positioners integrated into each of the one or more receivers configured to receive a sensor and to hold the sensor in position while emitting and receiving signals.

10. The system of claim 1, wherein the sensors are ultrasonic transducers.

11. The system of claim 2, wherein the sensors are microwave emitting and receiving devices.

12. A vehicle bumper system configured to detect objects proximate to the bumper, comprising:
a plurality of sensors positioned in the bumper so that a facing of the sensor is oriented in a direction to emit energy into an area adjacent to the bumper, wherein the sensors are coupled to the bumper by fasteners integrally coupled to the bumper;
a processing circuit positioned on a tray, the tray being coupled to a portion of the bumper so that the processing circuit may be electrically coupled to each of the plurality of sensors, wherein the tray is configured to protect the processing circuit from environmental elements; and
one or more alerting devices electrically coupled to the processing circuit and configured to alert the driver of the vehicle when activated by the processing circuit.

13. The bumper of claim 12, wherein the tray seals to a portion of the bumper creating to prevent moisture from contacting the processing circuit.

14. The bumper of claim 12, wherein the alerting device is a visual indicator.

15. The bumper of claim 12, wherein the alerting device is an audio producing device.

16. The bumper of claim 12, further comprising:
logic in the processing circuit configured to vary an output signal communicated to the alerting device so that the alert varies as a function of the distance of a detected object from the vehicle as determined by the processing circuit.

17. The bumper of claim 12, further comprising:
a wiring harness configured to electrically couple one or more sensors positioned in a first area of the bumper with the processing unit that is located in a second area of the bumper.

18. The bumper of claim 12, further comprising:
a wiring entryway positioned in the tray configured so that one or more connectors may route so as to electrically couple the processing unit with one or more sensors and a power source.

19. The bumper of claim 12, wherein each of the one or more sensors are ultrasonic transducers.

20. The bumper of claim 12, wherein the ultrasonic transducers have a housing that is configured to snap into an integrated receiving portion so that a facing of the transducer is essentially flush with an outer surface of the bumper so that ultrasonic energy can be emitted into an area behind the vehicle and so that reflected ultrasonic energy can be received.

21. A method for detecting obstacles within a rear moving path of a vehicle, comprising the steps of:
energizing a processing circuit positioned within an essentially closed space in a bumper;
energizing a plurality of sensing devices positioned in the bumper and positioned so that a facing of each sensing device is oriented toward an area behind the vehicle;
emitting wireless energy signals from each of the sensing devices into an area in the rear moving path of the vehicle;
receiving reflected wireless energy signals when the wireless energy signals impact an obstacle within the rear moving path of the vehicle and travel back to one or more of the plurality of sensing devices;
receiving indication at the processing circuit that one or more sensing devices has received reflected wireless energy signals; and
transmitting an output signal from the processing circuit to one or more alerting devices in the vehicle to indicate detection of an obstacle in the rear moving path of the vehicle.

22. The method of claim 21, wherein the processing circuit is electrically coupled to one or more sensors on an opposite side of the bumper as the position of the processing circuit in the closed space.

23. The method of claim 21, wherein one or more sensing devices are partially located within the closed space, and wherein one or more other sensing devices are not located within the closed space.

23. The method of claim 21, wherein the closed space is formed by the bumper and a tray detachably fastenable to the bumper to permit access to the processing circuit.

24. The method of claim 23, wherein the tray seals to an interior portion of the bumper sufficiently to prevent moisture and debris from entering the closed space.

25. The method of claim 21, wherein the alerting device is a visual indicator configurable to illuminate as controlled by the processing circuit.

26. The method of claim 21, wherein the alerting device is an audible producing device controllable by the processing circuit to activate when an object is within the rear moving path of the vehicle.
